(19) United States
(12) Patent Application Publication
(10) Pub. No.: US 2008/0105828 A1
(43) Pub. Date: May 8, 2008

(54) TECHNIQUES FOR REMOVING MOLECULAR FRAGMENTS FROM AN ION IMPLANTER

(75) Inventors: Christopher R. HATEM, Cambridge, MA (US); Jay Thomas SCHEUER, Rowley, MA (US); Russell J. LOW, Rowley, MA (US); Morgan D. Evans, Manchester, MA (US); Jonathan Gerald ENGLAND, Horsham (GB)

Correspondence Address: HUNTON & WILLIAMS LLP/VARIAN SEMICONDUCTOR,;EQUIPMENT ASSOCIATES, INC., INTELLECTUAL PROPERTY DEPARTMENT, 1900 K STREET, N.W., SUITE 1200, WASHINGTON, DC, 20006-1109, US

(73) Assignee: Varian Semiconductor Equipment Associates, Inc., Gloucester, MA (US)

(21) Appl. No.: 11/733,973

(22) Filed: Apr. 11, 2007

Related U.S. Application Data
(60) Provisional application No. 60/857,954, filed on Nov. 8, 2006.

(51) Int. Cl. H01J 49/02; H01J 27/02

(52) U.S. Cl. 250/426; 250/281; 250/283

(57) ABSTRACT

Techniques for removing molecular fragments from an ion implanter are disclosed. In one particular exemplary embodiment, the techniques may be realized as an apparatus for removing molecular fragments from an ion implanter. The apparatus may comprise a supply mechanism configured to couple to an ion source chamber and to supply a feed material to the ion source chamber. The apparatus may also comprise one or more hydrogen-absorbing materials placed in a flow path of the feed material, to prevent at least one portion of hydrogen-containing molecular fragments in the feed material from entering the ion source chamber.

### CROSS-REFERENCE TO RELATED APPLICATIONS

This patent application claims priority to U.S. Provisional Patent Application No. 60/857,954, filed Nov. 8, 2006, which is hereby incorporated by reference herein in its entirety.

This patent application is related to U.S. patent application Ser. No. 11/342,183, filed Jan. 26, 2006, which is hereby incorporated by reference herein in its entirety.

### FIELD OF THE DISCLOSURE

The present disclosure relates generally to semiconductor manufacturing and, more particularly, to techniques for removing molecular fragments from an ion implanter.

### BACKGROUND OF THE DISCLOSURE

Ion implantation is a process of depositing chemical species into a substrate by direct bombardment of the substrate with energized ions. In semiconductor manufacturing, ion implanters are used primarily for doping processes that alter the type and level of conductivity of target materials. A precise doping profile in an integrated circuit (IC) substrate and its thin-film structure is often crucial for proper IC performance. To achieve a desired doping profile, one or more ion species may be implanted in different doses and at different energies.

FIG. 1 depicts a traditional ion implanter system 100 in which a technique for low-temperature ion implantation may be implemented in accordance with an embodiment of the present disclosure. As is typical for most ion implanter systems, the system 100 is housed in a high-vacuum environment. The ion implanter system 100 may comprise an ion source 102, biased to a potential by a power supply 101. The ion source 102 is typically contained in a vacuum chamber known as a source housing (not shown). The ion implanter system 100 may also comprise a complex series of beam-line components through which an ion beam 10 passes. The series of beam-line components may include, for example, extraction electrodes 104, a 90° magnet analyzer 106, a first deceleration (D1) stage 108, a 70° magnet collimator 110, and a second deceleration (D2) stage 112. Much like a series of optical lenses that manipulate a light beam, the beam-line components can filter and focus the ion beam 10 before steering it towards a target wafer. During ion implantation, the target wafer is typically mounted on a platen 114 that can be moved in one or more dimensions (e.g., translate, rotate, and tilt) by an apparatus, sometimes referred to as a “roplat.”

With continued miniaturization of semiconductor devices, there has been an increased demand for ultra-shallow junctions. For example, tremendous effort has been devoted to creating shallower, more abrupt, and better activated source-drain extension (SDE) junctions to meet the needs of modern complementary metal-oxide-semiconductor (CMOS) devices.

In order to achieve ultra-shallow junctions, high-perveance (i.e., low-energy and high-beam-current) ion beams are desirable. For a traditional atomic ion beam (i.e., an ion beam consisting of single-species atomic ions), a low energy is required to place dopant ions within a shallow region from the surface of a target wafer, and a high beam current is desirable to maintain an acceptable throughput during production. However, a low-energy ion beam suffers from space charge effect as like-charged ions in the ion beam mutually repel each other and thereby cause the ion beam to expand. Due to the space charge effect, the magnitude of the beam current that can be transported in a beam-line is limited.

When the like-charged ions are positive ions, the space charge effect can be controlled, to some extent, by introducing electrons into the ion beam. The negative charges on the electrons counteract the repulsion among the positive ions. Since electrons can be produced when beam ions collide with background gas in the ion implanter, transport efficiency of a low-energy ion beam may be improved by increasing the pressure of background gas. However, this improvement in beam transport efficiency is limited, because, once the background gas pressure becomes high enough, a significant fraction of the beam ions will undergo charge-exchange interactions, resulting in a loss of beam current.

Compared to atomic ion beams, molecular ion beams (i.e., ion beams comprising charged molecules and/or fragments thereof) may be of a lower perveance. That is, molecular ion beams may be more easily transported at a higher energy and lower beam current than atomic ion beams. The plurality of atoms (including dopant species) in a molecular ion share an overall kinetic energy of the molecular ion according to their respective atomic masses. Therefore, to achieve a shallow implant equivalent to a low-energy atomic ion beam, a molecular ion beam may be transported at a higher energy. Since each molecular ion may contain several atoms of a dopant species and may be transported as a singly-charged species, the molecular ion beam current required to achieve a desired dopant dose may be smaller than that of an equivalent atomic ion beam. The capability of being transported at higher energies and lower beam currents makes molecular ion beams less susceptible to space-charge effects and therefore suitable for the formation of ultra-shallow junctions.

It is desirable to generate molecular ions with a standard ion source conventionally used for atomic ion implants. Molecules that can be ionized in such ion sources are described in the related U.S. patent application Ser. No. 11/342,183, which is incorporated by reference herein by its entirety. One type of ion sources that have been used in high-current ion implantation equipment are indirectly heated cathode (IHC) ion sources. FIG. 2 shows a traditional IHC ion source 200. The ion source 200 comprises an arc chamber 202 with conductive chamber walls 214. At one end of the arc chamber 202 there is a cathode 206 having a tungsten filament 204 located therein. The tungsten filament 204 is coupled to a first power supply 208 capable of supplying a high current. The high current may heat the tungsten filament 204 to cause thermionic emission of electrons. A second power supply 210 may bias the cathode 206 at a much higher potential than the tungsten filament 204 to cause the emitted electrons to accelerate to the cathode and thus heat up the cathode 206. The heated cathode 206 may then emit electrons into the arc chamber 202. A third power supply 212 may bias the chamber walls 214 with respect to the cathode 206 so that the electrons are accelerated at a high energy into the arc chamber. A source magnet (not shown) may create a magnetic field B inside the arc chamber 202 to confine the energetic electrons, and a repeller 216 at the other end of the arc chamber 202 may be biased at a same or similar potential as the cathode 206 to repel the energetic electrons. A gas source 218 may supply a reactive species (e.g., carborane) into the arc chamber 202. The gas source 218 may typically comprise a vaporizer 219 that heats up one or more feed materials and supplies the reactive species in gaseous form to the arc chamber 202. The energetic electrons may interact with the reactive species to produce a plasma 20. An extraction electrode (not shown) may then extract ions 22 from the plasma 20 for use in the ion implanter, for example, as illustrated in FIG. 1.

When molecular ions are generated in a conventional ion source such as the IHC ion source 200, molecules of the feed materials may interact with hot walls of the arc chamber 202 and/or the vaporizer 219. As a result, some of the molecules may break up into small molecular fragments, in particular hydrogen molecules. These small molecular fragments are difficult for vacuum equipment to pump out and therefore tend to contribute to pressure levels in the arc chamber 202, the ion source housing (not shown), and/or the beam-line (not shown). The molecular fragments might also reduce beam current through collisions with beam ions.

In view of the foregoing, it would be desirable to provide techniques for removing molecular fragments from an ion implanter which overcomes the above-described inadequacies and shortcomings.

### SUMMARY OF THE DISCLOSURE

Techniques for removing molecular fragments from an ion implanter are disclosed. In one particular exemplary embodiment, the techniques may be realized as an apparatus for removing molecular fragments from an ion implanter. The apparatus may comprise a supply mechanism configured to couple to an ion source chamber and to supply a feed material to the ion source chamber. The apparatus may also comprise one or more hydrogen-absorbing materials placed in a flow path of the feed material, to prevent at least one portion of hydrogen-containing molecular fragments in the feed material from entering the ion source chamber.

In accordance with other aspects of this particular exemplary embodiment, the one or more hydrogen-absorbing materials may be selected from a group consisting of: magnesium (Mg), palladium (Pd), titanium (Ti), platinum (Pt), uranium (U), cobalt (Co), zirconium (Zr), nickel-based alloys, lanthanum-based alloys, aluminum-based alloys, alloys based on V—Ti—Fe, and alloys based on Ti—Fe. The apparatus may be further configured to maintain the one or more hydrogen-absorbing materials in a first temperature range to absorb hydrogen-containing molecular fragments. The apparatus may also be further configured to heat the one or more hydrogen-absorbing materials to a second temperature range to outgas absorbed molecules or molecular fragments, or the apparatus may be further configured to heat the one or more hydrogen-absorbing materials to a second temperature range when absorption of molecular fragments is not desired.

In accordance with further aspects of this particular exemplary embodiment, the one or more hydrogen-absorbing materials may comprise double- or triple-bonded hydrocarbon molecules that absorb hydrogen-containing molecular fragments.

In accordance with additional aspects of this particular exemplary embodiment, the one or more hydrogen-absorbing materials may be placed in the flow path in a granular form for direct contact with the feed material.

In accordance with another aspect of this particular exemplary embodiment, the one or more hydrogen-absorbing materials may be incorporated into a matrix for selective contact with the feed material, the matrix allowing molecules up to a predetermined size to come into contact with the one or more hydrogen-absorbing materials.

In accordance with yet another aspect of this particular exemplary embodiment, the one or more hydrogen-absorbing materials may be mixed with the feed material in the supply mechanism.

In accordance with still another aspect of this particular exemplary embodiment, an interior surface of the supply mechanism may contain the one or more hydrogen-absorbing materials.

In accordance with a further aspect of this particular exemplary embodiment, the supply mechanism may comprise a nozzle that couples the supply mechanism to the ion source chamber, and wherein the one or more hydrogen-absorbing materials are placed within the nozzle. An interior surface of the nozzle may contain the one or more hydrogen-absorbing materials.

In another particular exemplary embodiment, the techniques may be realized as ion source. The ion source may comprise an arc chamber. The ion source may also comprise a vaporizer coupled to the arc chamber to supply a feed material to the arc chamber. The ion source may further comprise one or more hydrogen-absorbing materials placed in one or more locations in the ion source to remove at least one portion of hydrogen-containing molecular fragments from the feed material.

In accordance with other aspects of this particular exemplary embodiment, at least one of the one or more hydrogen-absorbing materials may be located in the vaporizer.

In accordance with further aspects of this particular exemplary embodiment, at least one of the one or more hydrogen-absorbing materials may be located in the arc chamber.

In yet another particular exemplary embodiment, the techniques may be realized as a method for removing molecular fragments from an ion implanter. The method may comprise coupling a supply mechanism to an ion source chamber to supply a feed material thereto. The method may also comprise generating, in the ion source chamber, molecular ions based on the feed material. The method may further comprise transporting an ion beam comprising the molecular ions down a beam-line. The method may additionally comprise absorbing hydrogen-containing molecular fragments with one or more hydrogen-absorbing materials in one or more locations selected from a group consisting of: the supply mechanism, the ion source chamber, a vacuum space that houses the ion source chamber, and the beam-line.

In still another particular exemplary embodiment, the techniques may be realized as an apparatus for removing molecular fragments. The apparatus may comprise a supply mechanism to supply a feed material to an ion source chamber. The apparatus may also comprise a nozzle to couple the supply mechanism to the ion source chamber, the nozzle comprising a selectively permeable membrane to filter molecular fragments out of the feed material supplied to the ion source chamber.

In accordance with other aspects of this particular exemplary embodiment, a sidewall of the nozzle may be made from the selectively permeable membrane.

In accordance with further aspects of this particular exemplary embodiment, a pressure difference across the selectively permeable membrane may cause the molecular fragments to diffuse through the selectively permeable membrane.

In accordance with additional aspects of this particular exemplary embodiment, the pressure difference may be caused by ion source housing vacuum outside the nozzle.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows a traditional ion implanter system.

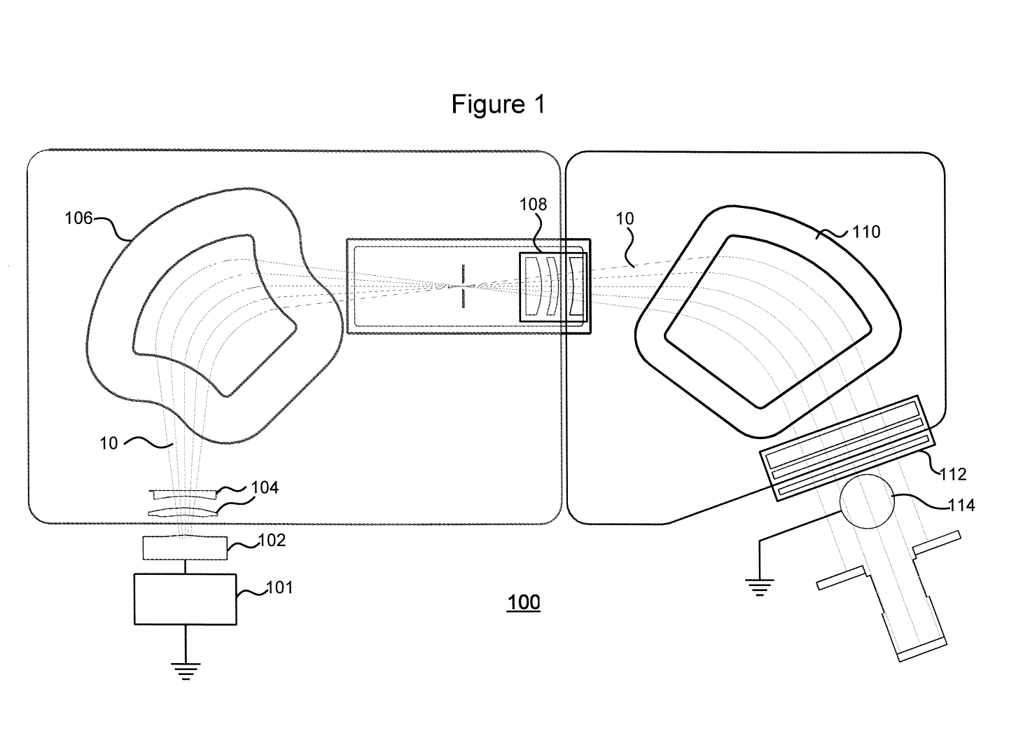

FIG. 2 shows a traditional IHC ion source in an ion implanter.

FIG. 3 shows a flow chart illustrating an exemplary method for removing molecular fragments from an ion implanter in accordance with an embodiment of the present disclosure.

FIG. 4 shows an exemplary ion source in which various approaches may be implemented to remove molecular fragments in accordance with an embodiment of the present disclosure.

FIG. 5 shows an exemplary vaporizer assembly for removing molecular fragments in accordance with an embodiment of the present disclosure.

FIG. 6 shows another exemplary vaporizer assembly for removing molecular fragments in accordance with an embodiment of the present disclosure.

FIG. 7 shows yet another exemplary vaporizer assembly for removing molecular fragments in accordance with an embodiment of the present disclosure.

### DETAILED DESCRIPTION OF EXEMPLARY EMBODIMENTS

Embodiments of the present disclosure may improve the use of molecular ion beams in ion implanters by removing therefrom molecular fragments generated in association with molecular ions. A variety of hydrogen-absorbing materials may be strategically placed in one or more locations within an ion implanter to remove at least a portion of hydrogen-containing molecular fragments. The hydrogen-absorbing materials may be prepared in a variety of forms and may absorb molecular fragments in physical and/or chemical processes. The hydrogen-absorbing materials may be further configured to selectively absorb molecular fragments.

The techniques disclosed herein are not limited to beam-line ion implanters, but are also applicable to other types of ion implanters such as those used for plasma doping (PLAD) or plasma immersion ion implantation (PIII).

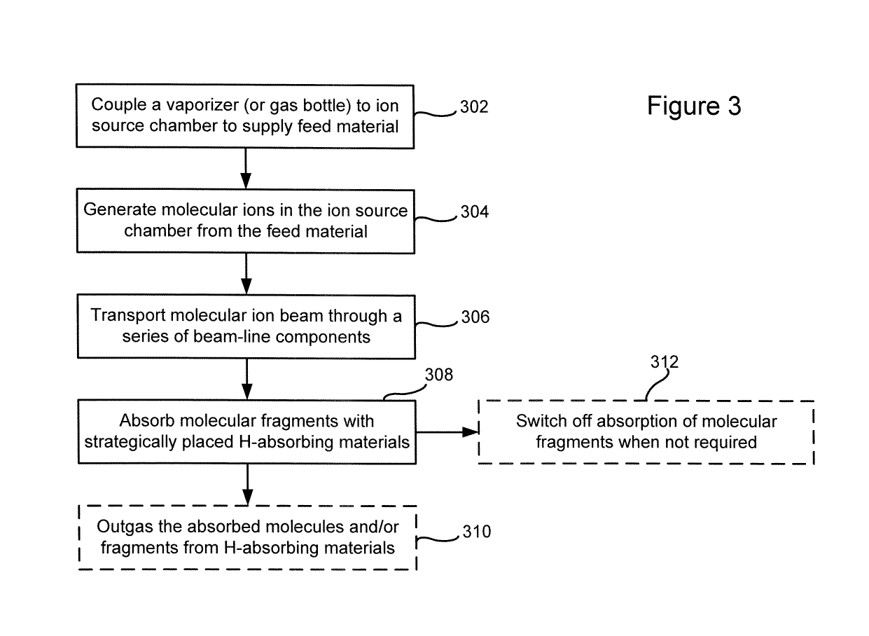

Referring to FIG. 3, there is shown a flow chart illustrating an exemplary method for removing molecular fragments from an ion implanter in accordance with an embodiment of the present disclosure.

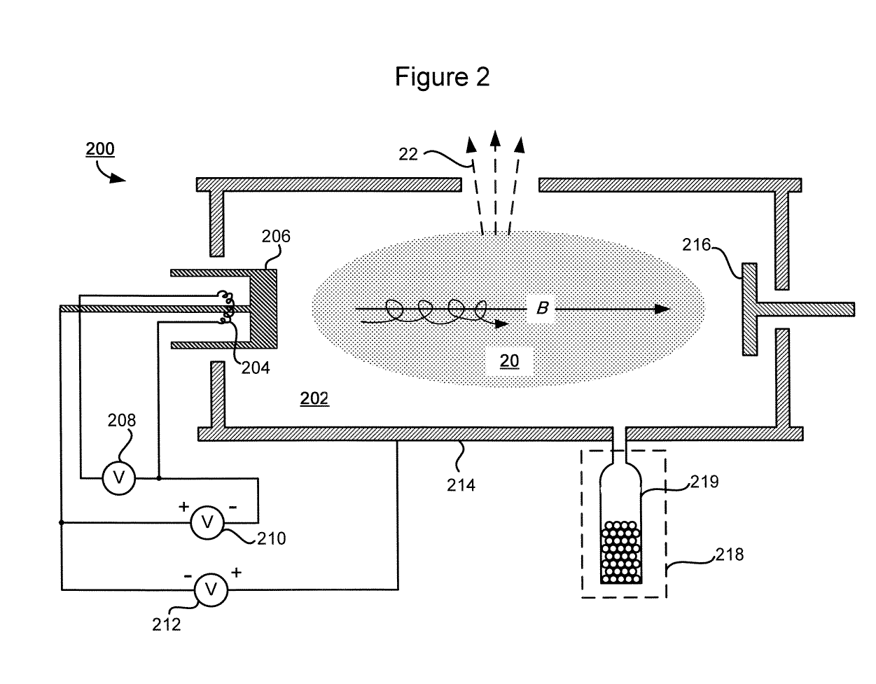

In step 302, a vaporizer may be coupled to an ion source chamber in an ion implanter. The vaporizer serves a main function of supplying a feed material to the ion source chamber for generation of molecular ions. For a gaseous feed material, a gas bottle may be used instead of a vaporizer. The ion source chamber may be similar to the arc chamber 202 shown in FIG. 2 or may be of any other configuration that is suitable for the generation of molecular ions.

The feed material may have any suitable chemical composition that allows it to be ionized to produce desired molecular ions. For example, decaborane (B₁₀H₁₂) and diborane (B₂H₆) may be used to produce boron-containing molecules. Other boron-containing feed material may be represented by a general formula XBY, wherein B represents boron, and X and Y each represent at least one element. Thus, boron-containing molecular ions may be generated based on the feed material XBY. In some cases, X and/or Y may represent single elements (e.g., X=C (i.e., carbon), Y=H (i.e., hydrogen)); and, in other cases, X and/or Y may represent more than one element (e.g., X=NH₄, NH₃, CH₃). In some embodiments, the feed material may be represented by another general formula XₐB_{b}Y_{c}, wherein a>0, b>0, and c>0. In preferred embodiments, X may comprise carbon (C), and/or Y may comprise hydrogen (H). It is preferable that the feed material has a relatively high molecular weight which results in formation of molecular ions also having relatively high molecular weight(s). It is also preferable that the feed material has a desired decomposition temperature. One example of XBY or XₐB_{b}Y_{c} is carborane (C₂B₁₀H₁₂).

The vaporizer may typically comprise a container that holds the feed material, a heating mechanism to turn the feed material (which may be in a solid or liquid form) into a gaseous form, and a coupling mechanism to interface with the ion source chamber. The vaporizer may be a permanent fixture attached to the ion source chamber. Alternatively, the vaporizer may preferably be a modular unit that can be freely removed or replaced. The coupling mechanism may either come with each modular vaporizer or be part of a fixed interface attached to the ion source chamber.

In step 304, molecular ions may be generated in the ion source chamber based on the feed material. The feed material may be supplied to the ion source chamber in a gaseous flow. Thermionic emission of electrons in the ion source chamber (or other ionization mechanism) may cause the feed material to be ionized, generating molecular ions.

In step 306, the molecular ions may be extracted from the ion source chamber, and a molecular ion beam so formed may be transported down a beam-line (i.e., through a series of beam-line components). The beam-line components may shape the molecular ion beam and tune the energy level of the molecular ions according to a desired ion implantation recipe.

In step 308, which may be concurrent with any or all of steps 302 through 306, molecular fragments may be removed from the ion implanter with one or more hydrogen-absorbing materials that are strategically placed in one or more locations within the ion implanter. The molecular fragments often contain hydrogen atoms and are generally smaller in size than the feed material molecules, which makes the molecular fragments difficult to pump out using conventional vacuum techniques. However, these hydrogen-containing molecular fragments may be physically or chemically removed by one or more hydrogen-absorbing materials.

The hydrogen-absorbing materials may include metals and/or alloys that physically absorb hydrogen and/or hydrogen-containing molecular fragments. For example, the hydrogen-absorbing materials may comprise one or more pure metals such as magnesium (Mg), palladium (Pd), titanium (Ti), platinum (Pt), uranium (U), cobalt (Co), and zirconium (Zr). Alternatively or additionally, the hydrogen-absorbing materials may include alloys based on nickel (Ni), lanthanum (La), and/or aluminum (Al), such as LaNi₍₅₋ₓ₎4.25Alₓ (where x has a value between 0 and 1), alloys based on V—Ti—Fe, and alloys based on Ti—Fe, wherein V represents vanadium and Fe represents iron.

The hydrogen-absorbing metal(s) and/or alloy(s) may be provided in the ion implanter in a granular form with which the feed material and any ion generation by-product can come into direct contact. Alternatively, the hydrogen-absorbing metal(s) and/or alloy(s) can be incorporated into a matrix that is based on, for example, polymer or glass. The matrix may be configured such that pores in the matrix are only large enough to admit molecules no more than a predetermined size. For example, the matrix may be configured to admit only small molecules (e.g., with sizes comparable to hydrogen), but not admit larger molecules that would poison the hydrogen-absorbing matrix.

Typically, to absorb the molecular fragments, the hydrogen-absorbing materials may be maintained at a lower temperature than the feed material (e.g., at room temperature). If the absorption of molecular fragments is not desired or needed for a particular ion implantation process, then, in step 312, the hydrogen-absorbing materials may be heated to a relatively high temperature to prevent any absorption from taking place. That way, the absorption function of the hydrogen-absorbing materials is effectively switched off without removing them from the ion implanter.

Absorption of hydrogen-containing molecular fragments by the metals and/or alloys may be a reversible process. If desired, the hydrogen-absorbing metals and/or alloys may be rejuvenated through an outgassing procedure in step 310. For example, after a molecular ion implantation process, the hydrogen-absorbing materials may be heated to a temperature high enough to outgas (i.e., release) the molecules that have been absorbed.

According to some embodiments of the present disclosure, the hydrogen-absorbing materials may include molecules that contain double- and/or triple-bonded hydrocarbons that may absorb hydrogen and survive at temperatures in excess of 100° C. Examples of suitable hydrogen-absorbing hydrocarbons are described in U.S. Pat. No. 5,624,598, which is hereby incorporated by reference herein in its entirety. One or more hydrogen-absorbing hydrocarbon species may be mixed with a catalyst and held in a matrix that imparts desirable properties such as malleability and imperviousness to poisoning gases. Absorption of hydrogen-containing molecular fragments by hydrogen-absorbing hydrocarbons is generally an irreversible process.

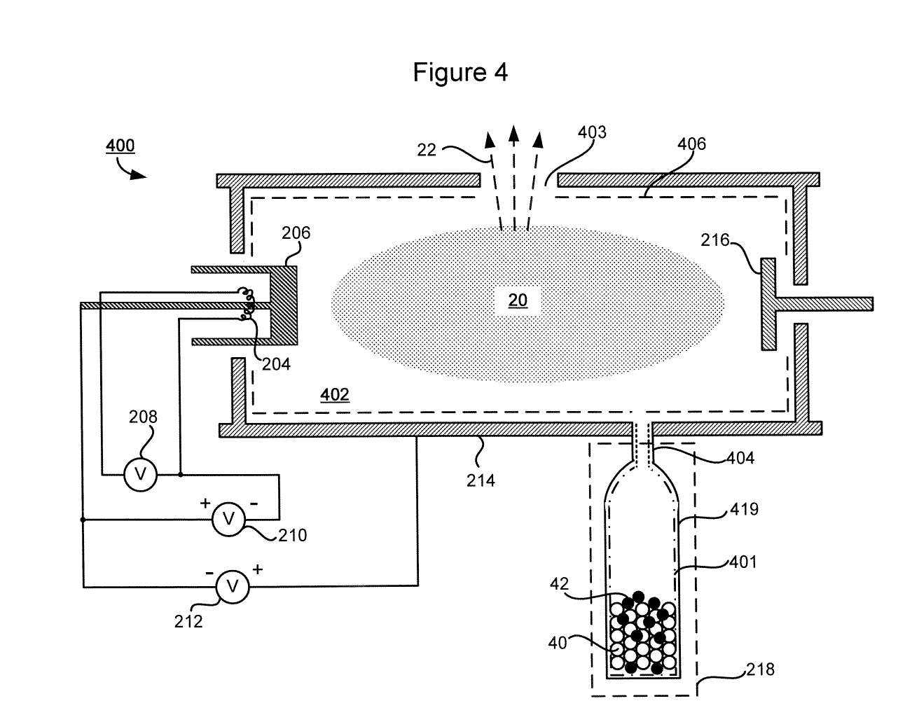

Hydrogen-absorbing materials may be strategically located in various parts of an ion implanter where the feed material and/or related by-products may be present, such as, for example, in the vaporizer, in the ion source chamber (or arc chamber), in the ion source housing, or elsewhere in the beam-line or an end station. Preferable locations are in a flow path of the feed material or where the hydrogen-absorbing materials can come into sufficient contact with the feed material and related by-products. FIG. 4 shows an exemplary ion source 400 in which various approaches may be implemented to remove molecular fragments in accordance with an embodiment of the present disclosure. The ion source 400 may be substantially the same as the ion source 200 shown in FIG. 2. A number of options are illustrated for the placement of the hydrogen-absorbing materials.

According to one embodiment, the above-described hydrogen-absorbing materials may be located in the ion source chamber, such as the IHC-type arc chamber 402. For example, one or more hydrogen-absorbing materials may be placed along interior walls 406 of the arc chamber 402. The interior walls 406 may be coated with or made from hydrogen-absorbing materials, preferably those types that can be outgassed. Alternatively, the interior walls 406 may be lined with the hydrogen-absorbing materials prepared in a matrix form.

The hydrogen-absorbing materials may also be placed at or near the ion extraction slit 403 to reduce the number of molecular fragments exiting the arc chamber 402. The temperature in the arc chamber may be sufficiently low (˜800° C.) when molecular ions are being generated, such that the hydrogen-absorbing materials may absorb the small molecular fragments. When running other ion species, the arc chamber may be heated to a higher temperature (e.g., ˜1000° C.) to outgas the hydrogen-absorbing materials. A specific species and operating regime may be chosen for the ion source for outgassing purposes prior to a molecular ion implantation process.

According to another embodiment, the hydrogen-absorbing materials may be placed in the source housing (not shown in FIG. 4). The hydrogen-absorbing materials may be kept cool (in some cases, at approximately room temperature) to absorb the molecular fragments during the generation of molecular ions. After running with the molecular implants, the material could be heated to outgas the molecules. In other words, the hydrogen-absorbing materials may be used as a sorbtion pump, like, for example, a titanium sublimation pump. The outgassing procedure may be performed at a time when the ion implanter is idling. The hydrogen-absorbing materials may be kept hot when the ion implanter is running other ion species, so that the hydrogen absorbing capacity is not poisoned.

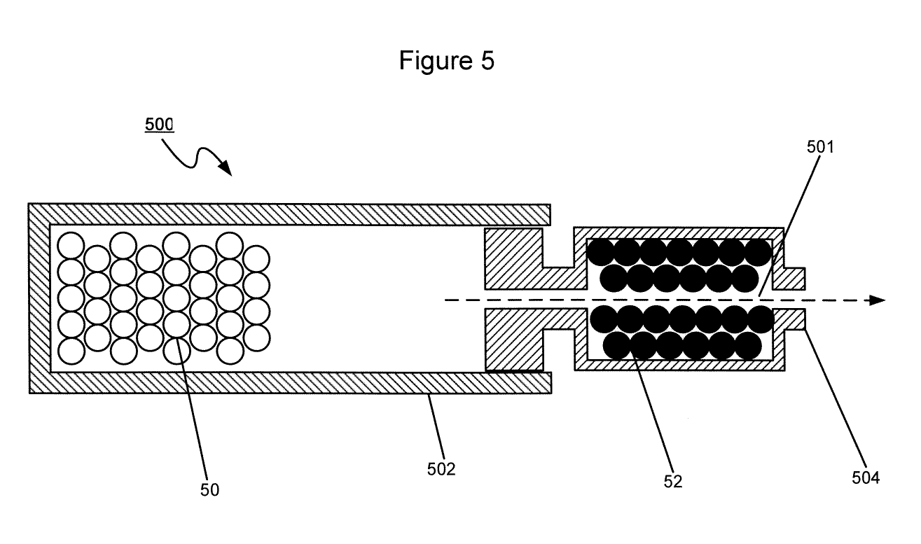

According to yet another embodiment, the hydrogen-absorbing materials may be placed in a vaporizer 419. For example, a hydrogen-absorbing material 42 may be directly mixed with a feed material 40. It may be preferable to pre-fill the vaporizer 419 (e.g., a disposable container) with a mixture of the feed material 40 and the hydrogen-absorbing material 42, such that any hydrogen or hydrogen-containing species generated during transportation or storage of the vaporizer 419 will be promptly absorbed. Otherwise, the accumulation of hydrogen or hydrogen-containing species in the container may lead to safety issues. Alternatively, interior surface 401 of the vaporizer 419 may be lined with, coated with, or made from one or more hydrogen-absorbing materials. More preferably, a coupling mechanism 404 (e.g., a nozzle) may contain hydrogen-absorbing materials in or near a flow path of the feed material 40 as it is supplied to the arc chamber 402, as will be described below in connection with FIG. 5.

The use of the above-described hydrogen-absorbing hydrocarbons may be best suited in the vaporizer, but may also be used in the ion source housing, the ion source chamber (e.g., arc chamber), or in the beam-line. Hydrogen-absorbing hydrocarbons may be mixed with the feed material in the vaporizer, for example in powder or pellet form. Alternatively, the hydrogen-absorbing hydrocarbons may be held separately in the vaporizer, for example, in a permeable container, or as a coating to the vaporizer wall. If the feed material is introduced into the vaporizer inside a separate crucible, the crucible may be coated or otherwise contain the hydrogen-absorbing hydrocarbons.

FIG. 5 shows an exemplary vaporizer assembly 500 for removing molecular fragments in accordance with an embodiment of the present disclosure. The vaporizer assembly 500 may comprise a vaporizer 502 (or a gas bottle) and a nozzle 504. The vaporizer 502 may contain a feed material 50 that can be vaporized by a heating mechanism (not shown) and supplied, via the nozzle 504, to an ion source chamber for generation of molecular ions. The nozzle 504 may be either fixed to or removable from the vaporizer 502. The nozzle 504 may contain a hydrogen-absorbing material 52 that is placed in or near a flow path 501 of the feed material 50 on its way into the ion source chamber. As mentioned above, the hydrogen-absorbing material 52 may alternatively or additionally be packaged with the feed material 50, either as a mixture or held separately from the feed material 50 for ease of transportation and storage.

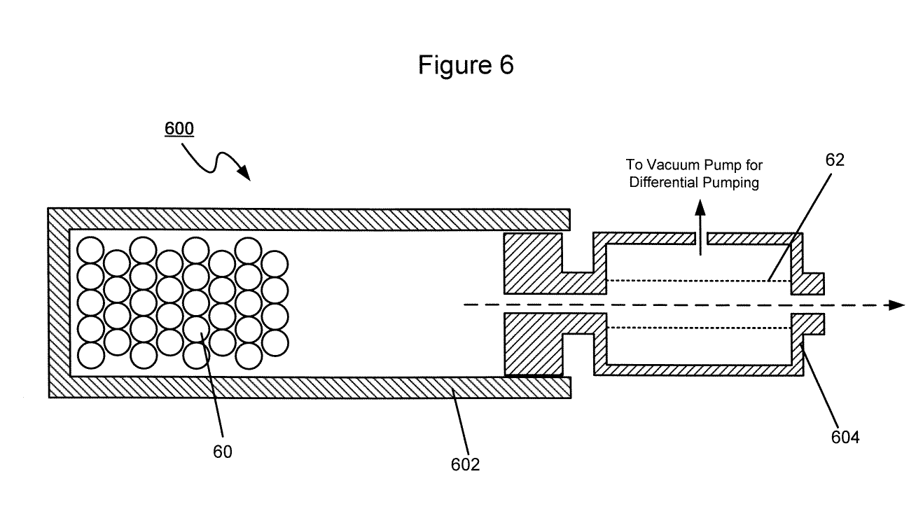

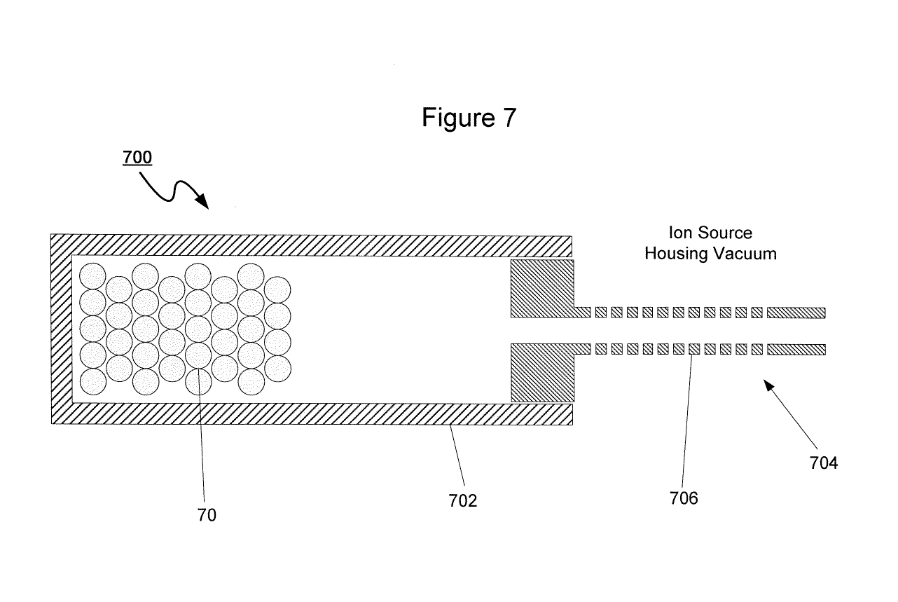

According to embodiments of the present disclosure, a membrane filter may be implemented in a vaporizer assembly to selectively remove small molecular fragments from a gaseous feed material supplied to an ion source chamber. FIGS. 6 and 7 show two exemplary vaporizer assemblies with membrane filters in accordance with embodiments of the present disclosure.

As shown in FIG. 6, a vaporizer assembly 600 may comprise a vaporizer 602 and a nozzle 604. The vaporizer 602 may contain a feed material 60 that can be vaporized and supplied, via the nozzle 604, to an ion source chamber for generation of molecular ions. The nozzle 604 may be either fixed to or removable from the vaporizer 602. Near a flow path of the vaporized feed material (i.e., on its way to the ion source chamber), a membrane 62 may be provided in the nozzle 604. The membrane 62 may be selectively permeable such that only molecular fragments up to a certain size can diffuse through the membrane 62. A vacuum space on the other side of the membrane 62 may be differentially pumped in order to drive the selective permeation of the smaller molecular fragments. As a result, unwanted molecular fragments may be filtered out and only large molecules are allowed to enter the ion source chamber.

FIG. 7 shows a more preferable implementation of a membrane filter which, in contrast to the vaporizer assembly 600 as shown in FIG. 6, may not require a differential pump. A vaporizer assembly 700 may comprise a vaporizer 702 and a nozzle 704. The vaporizer 702 may contain a feed material 70 that can be vaporized and supplied to an ion source chamber. The sidewall of the nozzle 704 may be made of a selectively permeable membrane that allows small molecules and/or molecular fragments to diffuse through. The ion source housing vacuum, on the outside of the nozzle 704, may help drive the diffusion of small molecules or molecular fragments through the sidewall of the nozzle 704. Therefore, unlike the embodiment shown in FIG. 6, a separate differential pump does not need to be provided for the nozzle 704.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An apparatus for removing molecular fragments from an ion implanter, the apparatus comprising:
a supply mechanism configured to couple to an ion source chamber and to supply a feed material to the ion source chamber; and
one or more hydrogen-absorbing materials placed in a flow path of the feed material, to prevent at least one portion of hydrogen-containing molecular fragments in the feed material from entering the ion source chamber.

2. The apparatus according to claim 1, wherein the one or more hydrogen-absorbing materials are selected from a group consisting of: magnesium (Mg), palladium (Pd), titanium (Ti), platinum (Pt), uranium (U), cobalt (Co), zirconium (Zr), nickel-based alloys, lanthanum-based alloys, aluminum-based alloys, alloys based on V—Ti—Fe, and alloys based on Ti—Fe.

3. The apparatus according to claim 1, wherein the one or more hydrogen-absorbing materials comprise double- or triple-bonded hydrocarbon molecules that absorb hydrogen-containing molecular fragments.

4. The apparatus according to claim 1, wherein the one or more hydrogen-absorbing materials are placed in the flow path in a granular form for direct contact with the feed material.

5. The apparatus according to claim 1, wherein the one or more hydrogen-absorbing materials are incorporated into a matrix for selective contact with the feed material, the matrix allowing molecules up to a predetermined size to come into contact with the one or more hydrogen-absorbing materials.

6. The apparatus according to claim 1, wherein the one or more hydrogen-absorbing materials are mixed with the feed material in the supply mechanism.

7. The apparatus according to claim 1, wherein the supply mechanism comprises a container pre-filled with a mixture of the feed material and the one or more hydrogen-absorbing materials.

8. The apparatus according to claim 1, wherein an interior surface of the supply mechanism contains the one or more hydrogen-absorbing materials.

9. The apparatus according to claim 1, wherein the supply mechanism comprises a nozzle that couples the supply mechanism to the ion source chamber, and wherein the one or more hydrogen-absorbing materials are placed within the nozzle.

10. The apparatus according to claim 9, wherein an interior surface of the nozzle contains the one or more hydrogen-absorbing materials.

11. An ion source comprising:
an ion source chamber;
a supply mechanism coupled to the arc chamber to supply a feed material to the arc chamber; and
one or more hydrogen-absorbing materials placed in one or more locations in the ion source to remove at least one portion of hydrogen-containing molecular fragments from the feed material.

12. The ion source according to claim 11, wherein at least one of the one or more hydrogen-absorbing materials is located in the supply mechanism.

13. The ion source according to claim 11, wherein at least one of the one or more hydrogen-absorbing materials is located in the ion source chamber.

14. The ion source according to claim 11, wherein at least one of the one or more hydrogen-absorbing materials is located in a vacuum space that houses the ion source chamber.

15. The ion source according to claim 11, wherein the one or more hydrogen-absorbing materials are maintained in a first temperature range to absorb hydrogen-containing molecular fragments.

16. The ion source according to claim 11, wherein the one or more hydrogen-absorbing materials are heated to a second temperature range to outgas absorbed molecules or molecular fragments.

17. The ion source according to claim 11, wherein the one or more hydrogen-absorbing materials are heated to a second temperature range when absorption of molecular fragments is not desired.

18. The ion source according to claim 11, wherein the supply mechanism comprises a container pre-filled with a mixture of the feed material and the one or more hydrogen-absorbing materials.

19. A method for removing molecular fragments from an ion implanter, the method comprising the steps of:
coupling a supply mechanism to an ion source chamber to supply a feed material thereto;
generating, in the ion source chamber, molecular ions based on the feed material;
transporting an ion beam comprising the molecular ions down a beam-line; and
absorbing hydrogen-containing molecular fragments with one or more hydrogen-absorbing materials in one or more locations selected from a group consisting of: the supply mechanism, the ion source chamber, a vacuum space that houses the ion source chamber, the beam-line and an end station.

20. The method according to claim 19, further comprising:
maintaining the one or more hydrogen-absorbing materials in a first temperature range to absorb hydrogen-containing molecular fragments.

21. The method according to claim 19, further comprising:
heating the one or more hydrogen-absorbing materials to a second temperature range to outgas absorbed molecules or molecular fragments.

22. The method according to claim 19, further comprising:
heating the one or more hydrogen-absorbing materials to a second temperature range when absorption of molecular fragments is not desired.

23. An apparatus for removing molecular fragments, the apparatus comprises:
a supply mechanism to supply a feed material to an ion source chamber; and
a nozzle to couple the supply mechanism to the ion source chamber, the nozzle comprising a selectively permeable membrane to filter molecular fragments out of the feed material supplied to the ion source chamber.

24. The apparatus according to claim 23, wherein a sidewall of the nozzle is made from the selectively permeable membrane.

25. The apparatus according to claim 23, wherein a pressure difference across the selectively permeable membrane causes the molecular fragments to diffuse through the selectively permeable membrane.

26. The apparatus according to claim 25, wherein the pressure difference is caused by ion source housing vacuum outside the nozzle.
